(19) United States
(12) Patent Application Publication
(10) Pub. No.: US 2012/0026032 A1
(43) Pub. Date: Feb. 2, 2012

(54) CROSS-POLARIZATION COMPONENT CANCELLATION

(75) Inventor: Jesse P. Sigmund, Sachse, TX (US)

(73) Assignee: Verizon Patent and Licensing Inc., Basking Ridge, NJ (US)

(21) Appl. No.: 12/848,490

(22) Filed: Aug. 2, 2010

(51) Int. Cl. H04B 7/185; H01Q 21/06

(52) U.S. Cl. 342/353; 342/361

(57) ABSTRACT

A system includes a remote station configured to transmit a first signal having a co-polarization component and a first cross-polarization component. A satellite is configured to receive the first signal and transmit a repeated signal that substantially includes the first signal. A monitoring station is configured to isolate the repeated signal received from the satellite. Isolating the repeated signal generates a second signal having the co-polarization component, the first cross-polarization component, and a second cross-polarization component. The monitoring station is further configured to substantially reduce the second cross-polarization component of the second signal. A method includes receiving a signal having a co-polarization component and a plurality of cross-polarization components, manipulating the co-polarization component, and introducing the manipulated co-polarization component to the plurality of cross-polarization components.

### BACKGROUND

Telecommunications providers transmit signals with different polarity components (e.g., horizontal and vertical components) as a way to differentiate between signals with the same or similar frequencies. This gives the telecommunications provider more options for transmitting information at a particular frequency. The intended polarization component is known as the co-polarization component and the unintended polarization component is known as the cross-polarization component. Ideally, a transmitting station transmits only the co-polarization component of the signal to a satellite because the cross-polarization component is received as noise. Furthermore, the satellite ideally only transmits the co-polarization component of the signal to a monitoring station. In reality, however, both the co-polarization component and the cross-polarization component are transmitted from the transmitting station to the satellite and from the satellite to the monitoring station. Additionally, the monitoring station is unable to completely isolate the co-polarization and cross-polarization components from the signals received from the satellite, causing further noise. Accordingly, a system is needed that reduces the noise caused by the monitoring station.

### BRIEF DESCRIPTION OF THE DRAWINGS

FIG. 1 illustrates an exemplary system having a remote station, a satellite, and a monitoring station that is configured to reduce the noise created by a cross-polarization component of a signal.

FIG. 2 illustrates an exemplary diagram of the components of the remote station, the satellite, and the monitoring station.

FIG. 3 illustrates an exemplary circuit diagram of the monitoring station that is configured to reduce noise created by the cross-polarization component of the signal.

FIG. 4 illustrates an exemplary process flow diagram implemented by the system of FIG. 1.

### DETAILED DESCRIPTION

A system includes a remote station configured to transmit a first signal having a co-polarization component and a first cross-polarization component to a satellite. The co-polarization component is the component of the signal transmitted at the intended polarity (e.g., a horizontal or vertical polarity). The cross-polarization component is the component of the signal transmitted at the unintended polarity and is received at the satellite as noise. Various factors contribute to cross-polarization. For instance, the alignment of the remote station relative to the satellite can cause cross-polarization. The satellite receives the first signal and transmits a repeated signal that substantially includes the first signal to a monitoring station. The monitoring station receives and isolates the repeated signal received from the satellite. That is, the monitoring station separates the co-polarization component and the cross-polarization component from the repeated signal. Doing so, however, generates a second signal having the co-polarization component, the first cross-polarization component, and a second cross-polarization component (e.g., noise from the monitoring station). The monitoring station is further configured to substantially reduce the second cross-polarization component of the second signal. For example, the monitoring station includes a tuning circuit that substantially reduces the cross-polarization component of the signal and a feedback circuit that iteratively adjusts the tuning circuit until the second cross-polarization component of the signal is substantially reduced. Accordingly, a process implemented by the system disclosed herein includes receiving a signal having a co-polarization component and a plurality of cross-polarization components, manipulating the co-polarization component, and introducing the manipulated co-polarization component to the plurality of cross-polarization components to substantially reduce at least one of the cross-polarization components.

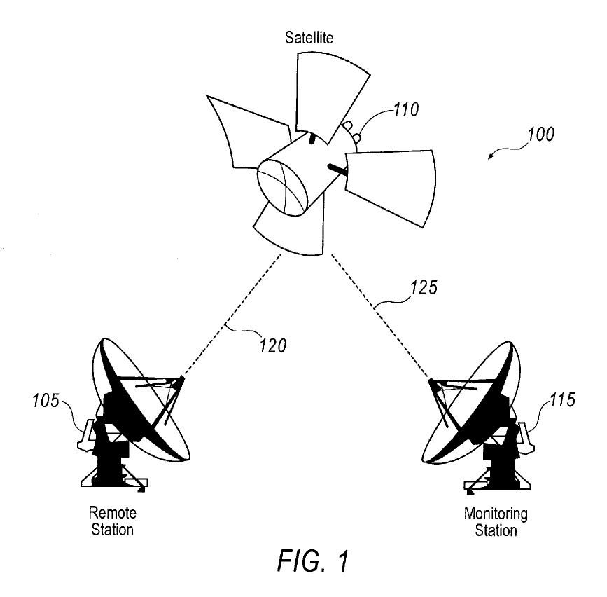

FIG. 1 illustrates an exemplary system 100 that is configured to substantially reduce noise generated by a cross-polarization component of a signal. The system 100 may take many different forms and include multiple and/or alternate components and facilities. While an exemplary system 100 is shown in FIG. 1, the exemplary components illustrated in the figures are not intended to be limiting. Indeed, additional or alternative components and/or implementations may be used.

As illustrated in FIG. 1, the system 100 includes a remote station 105, a satellite 110, and a monitoring station 115. The remote station 105 acts as a signal source configured to transmit a test signal 120 to the satellite 110, and the satellite 110 also acts as a signal source configured to transmit a repeated signal 125 to the monitoring station 115. Both the test and repeated signals 120, 125 may have components of different polarities. For instance, both the test and repeated signals 120, 125 may have horizontal and vertical components. The remote station 105 and satellite 110, therefore, may be configured to transmit signals with either or both polarity components. The satellite 110 and monitoring station 115 may be configured to receive signals with either or both polarity components.

While the remote station 105 may be configured to transmit the test signal 120 with an intended polarity component (e.g., a co-polarization component), the remote station 105 may additionally transmit the test signal 120 with an unintended polarity component (e.g., a first cross-polarization component). The first cross-polarization component is received as noise by the satellite 110. The satellite 110 transmits the repeated signal 125 with the co-polarization component and the first cross-polarization component from the test signal 120 to the monitoring station 115. Therefore, the monitoring station 115 receives the repeated signal 125, which includes the co-polarization component and the first cross-polarization component (e.g., noise from the remote station 105.

The monitoring station 115, in one exemplary approach, may be used to monitor the signals transmitted by the remote station 105 to, for instance, determine whether the remote station 105 is operating properly. The monitoring station 115, therefore, is configured to differentiate noise transmitted by the remote station 105 from other types of noise (e.g., noise transmitted by the satellite 110 or caused by the monitoring station 115 itself). Unless accounted for, noise caused by the monitoring station 115 is unfairly attributed to the remote station 105. The monitoring station 115 is configured to polarize the repeated signal 125. Doing so, however, generates a signal with the co-polarization component, the first cross-polarization component, and a second cross-polarization component. The second cross-polarization component represents noise generated by the monitoring station 115. The monitoring station 115 is configured to identify the second cross-polarization component of the repeated signal 125 as noise and substantially reduce the second cross-polarization component so that the monitoring station 115 can properly monitor the quality of the test signal 120 transmitted by the remote station 105.

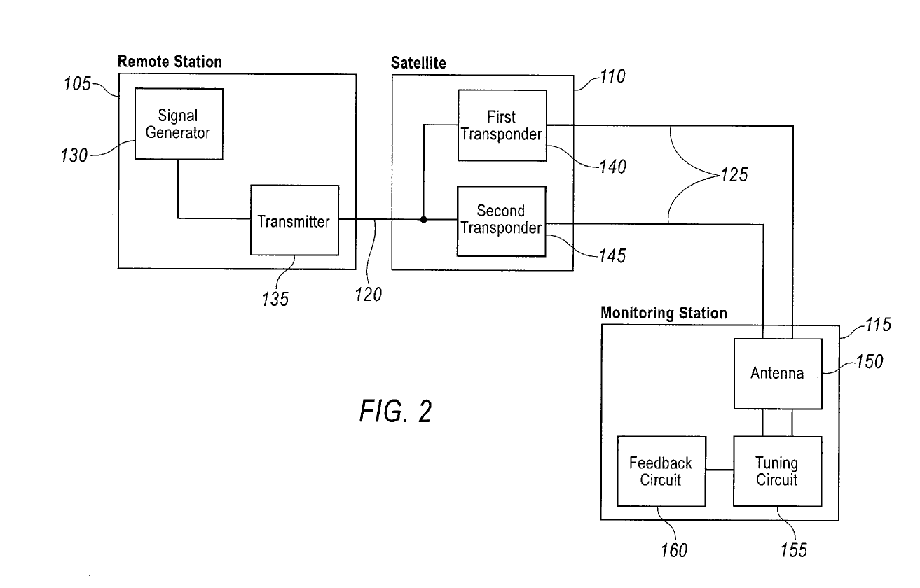

FIG. 2 illustrates an exemplary diagram of the components of the remote station 105, the satellite 110, and the monitoring station 115. The remote station 105 includes a signal generator 130 and a transmitter 135. The signal generator 130 may include any device configured to generate the test signal 120. The signal generator 130 may be configured to generate the test signal 120 at a particular frequency. For instance, the signal generator 130 may generate the test signal 120 at a frequency of 11.7 to 12.2 GHz or 140.-14.5 GHz for the Ku band. Of course, the signal generator 130 may generate the test signal 120 at another frequency or range of frequencies. The signal generator 130 may be configured to generate the test signal 120. The rotation of the antenna feed system of the remote station 105 may set the desired polarity. However, the feed system may have a limited ability to polarize the signal to the intended polarity (e.g., the co-polarization component) resulting in some isolation component (e.g., the cross-polarization component). The azimuth and elevation alignment of the antenna of the remote station 105 to the satellite 110 may also contribute to this isolation. Accordingly, the remote station 105 may transmit the test signal 120 to have the co-polarization component, the first cross-polarization component, or both. In one particular approach, the remote station 105 is configured to generate the test signal 120 with more power directed to the co-polarization component than directed to the first cross-polarization component. The transmitter 135 may include any device configured to transmit the test signal 120 to the satellite 110. The transmitter 135 may, for instance, include an antenna that is configured to propagate an electromagnetic signal to the satellite 110.

The satellite 110 may include any device configured to receive the test signal 120 transmitted by the remote station 105. The satellite 110 may orbit the Earth and receive signals from the remote station 105 when the satellite 110 and remote station 105 are visually aligned. The satellite 110 may include a plurality of transponders that are configured to receive a polarity component of the test signal 120 and transmit the received polarity component to the monitoring station 115 as the repeated signal 125. In one exemplary approach, each transponder may be dedicated to a specific polarity component of received signals. For instance, a first transponder 140 may be dedicated to a vertical component of received signals while a second transponder 145 may be dedicated to a horizontal component of received signals. Therefore, the first transponder 140 may receive the co-polarization component of the test signal 120 while the second transponder 145 may receive the first cross-polarization component of the test signal 120. The transponders 140, 145 act as repeaters to transmit the co-polarization component and first cross-polarization component of the test signal 120 to the monitoring station 115 as part of the repeated signal 125. Due to imperfections with alignment between the satellite 110 and the monitoring station 115 such as azimuth, elevation, and rotation, the satellite 110 may further transmit its own cross-polarization component to the monitoring station 115 as part of the repeated signal 125. However, this cross-polarization component may be relatively small and not add a significant amount of noise to the cross-polarization component of the test signal 120.

The monitoring station 115 may include any device configured to monitor the signals transmitted by the remote station 105. For instance, the monitoring station 115 may include an antenna 150 configured to receive the repeated signal 125 generated by the satellite 110. The monitoring station 115 may further include a polarizer (not shown) that is configured to isolate the co-polarization component and the first cross-polarization component of the repeated signal 125. However, the antenna may generate noise when isolating the repeated signal 125. This noise is represented as the second cross-polarization component. Therefore, the output of the antenna includes the co-polarization component and the first and second cross-polarization components. The monitoring station includes a tuning circuit 155 configured to substantially remove the noise (e.g., the second cross-polarization component) created by the monitoring station 115, and a feedback circuit 160 configured to control the tuning circuit 155.

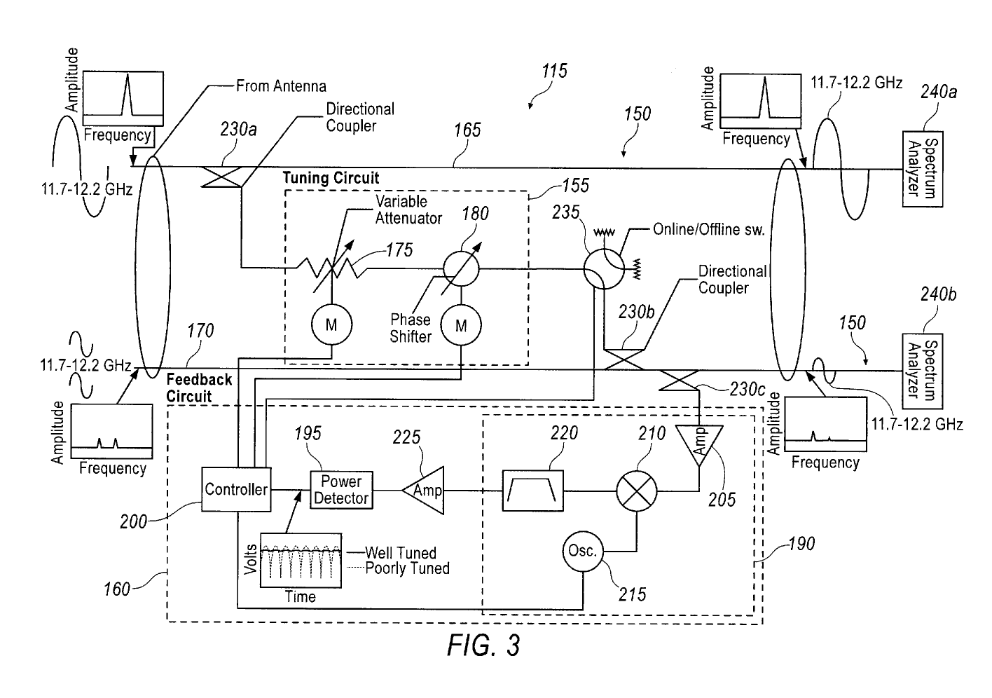

FIG. 3 illustrates the exemplary components of the antenna 150, the tuning circuit 155, and the feedback circuit 160. The antenna 150 receives the repeated signal 125 from the satellite 110 and outputs a signal with the co-polarization component and the first and second cross-polarization components. The tuning circuit 155 generates a cancelling signal, which is coupled to the cross-polarization components of the repeated signal 125 resulting in a filtered signal. Thus, the filtered signal includes the first cross-polarization component and a substantially reduced second cross-polarization component. The feedback circuit 160 monitors the filtered signal and controls the tuning circuit 155 to substantially reduce the second cross-polarization component from the filtered signal.

The antenna 150 includes a first portion 165 configured to receive the co-polarization component of the repeated signal 125 from the polarizer (not shown). The co-polarization component of the repeated signal 125 is representative of the co-polarization component of the test signal 120. The antenna 150 further includes a second portion 170 configured to receive the first and second cross-polarization components of the repeated signal 125 from the polarizer (not shown), which includes the first cross-polarization component of the test signal 120 received at the second transponder 145 from the remote station 105 and transmitted to the monitoring station 115 (e.g., noise from the remote station 105) and the second cross-polarization component caused by the polarizer in the antenna 150 (e.g., noise from the monitoring station 115).

The tuning circuit 155 is configured to detect the noise from the monitoring station 115 and substantially reduce the noise. In one exemplary approach, the noise from the monitoring station 115 has the same frequency as the co-polarization component of the repeated signal 125 since the co-polarization component and the noise (e.g., the second cross-polarization component) were transmitted from the same transponder (e.g., the first transponder 140) of the satellite 110. Because the monitoring station 115 generates the second cross-polarization component from the co-polarization component, both the co-polarization component and the cross-polarization component have the same frequency because both were transmitted by the first transponder 140.

Accordingly, the tuning circuit 155 may use the frequency of the co-polarization component to cancel the second cross-polarization component. For instance, the tuning circuit 155 may be configured to cancel the second cross-polarization component by coupling the cancelling signal to the second portion 170 of the antenna 150 since, in one exemplary approach, the cancelling signal has the same frequency and magnitude, but opposite phase, as the second cross-polarization component. Thus, coupling the cancelling signal to the second portion 170 of the antenna 150 substantially cancels the second cross-polarization component, leaving only the first cross-polarization component.

The tuning circuit 155 may include a variable attenuator 175 and a phase shifter 180. The variable attenuator 175 may be in communication with the first portion 165 of the antenna 150 and may include any device configured to attenuate a signal. The output of the variable attenuator 175 may be a signal with the same frequency but different magnitude as the co-polarization component of the repeated signal 125. The amount of the attenuation may be variable. As discussed in greater detail below, the feedback circuit 160 may control the amount of the attenuation.

The phase shifter 180 may also be in communication with the first portion 165 of the antenna 150 and include any device configured to shift a phase of the co-polarization component of the repeated signal 125. The phase of an oscillating signal is the fraction of a complete cycle corresponding to an offset in the displacement from a specified reference point. Phase may be represented as an angle or radians. The phase shifter 180 can be used to substantially cancel a signal or a portion of a signal. A complete cycle of an oscillating signal is 360 degrees or 27c radians. Therefore, two signals with the same magnitude and frequency will cancel each other if they are 180 degrees or π radians out of phase. The phase shifter 180 may be configured to shift the signal received from the variable attenuator 175 by 180 degrees to generate the cancelling signal, which has the same frequency and magnitude, but opposite phase, of the second cross-polarization component. Adding the cancelling signal to the second portion 170 of the antenna 150 results in the filtered signal that includes the first cross-polarization component and a substantially reduced second cross-polarization component.

The feedback circuit 160 includes a closed-loop control system that may be configured to control the tuning circuit 155. In particular, the feedback circuit 160 may be configured to measure the filtered signal on the second portion 170 of the antenna 150 and adjust the elements of the tuning circuit 155, such as the variable attenuator 175, phase shifter 180, or both until the second cross-polarization component is substantially reduced. The feedback circuit 160 may include a down converter 190, an amplifier 205, a power detector 195, and a controller 200.

The down converter 190 may be in communication with the second portion 170 of the antenna 150 to measure the filtered signal. The down converter 190 may be used to convert the frequency of the filtered signal, for instance, to make processing easier. The filtered signal may have a frequency of between approximately 11.7 and 12.2 GHz, and the down converter 190 may be configured to reduce the frequency to approximately 1 GHz or below. The down converter 190 may include an amplifier 205, a mixer 210 and oscillator 215, and a filter 220.

The amplifier 205 may be configured to change the magnitude of the filtered signal. For instance, the magnitude of the filtered signal may be relatively low, so the amplifier 205 may increase the magnitude to make processing the filtered signal easier. The amplifier 205 may include any device, such as an operational amplifier, configured to amplify the filtered signal.

The mixer 210 and oscillator 215 may be configured to change the frequency of the filtered signal. Again, the filtered signal may have a frequency between approximately 11.7 and 12.2 GHz. It may be difficult to process signals in this frequency range. Accordingly, the mixer 210 and oscillator 215 may be configured to reduce the frequency to approximately 1 GHz or below.

The filter 220 may be configured to isolate the first and second cross-polarization components from the filtered signal. As discussed above, the filtered signal includes the first cross-polarization component and the substantially reduced second cross-polarization component. The tuning circuit 155 is configured to remove noise caused by the monitoring station 115 based on the peak-to-peak power of the first and second cross-polarization components. The filter 220, therefore, is configured to remove most signals other than the first and second cross-polarization components from the filtered signal. This is so the feedback circuit 160 can control the tuning circuit 155 based on the sum of the powers of the first and second cross-polarization component.

Another amplifier 225 may be configured to amplify the signal received from the down converter 190. The signal from the down converter 190 may have a relatively low magnitude, so this amplifier 225 may be used to increase the magnitude to make processing easier. Like the amplifier 205 in the down converter 190, this amplifier 225 may include any device, such as an operational amplifier, configured to amplify the signal received from the down converter 190.

The power detector 195 is any device configured to receive the amplified signal from the down converter 190 and determine the power of the first and second cross-polarization components from that amplified signal. The power detector 195 outputs a voltage signal that is proportional to the measured power. The power of the filtered signal will change over time if the tuning circuit 155 is not properly tuned. Therefore, any oscillations in the voltage signal indicate the additional tuning may be necessary to substantially cancel the second cross-polarization component. Of course, the feedback circuit 160 may be configured to allow a small variation in peak-to-peak power. Even though this small variation indicates that the second cross-polarization component is not completely eliminated, it may be made small enough to be insignificant.

The controller 200 is in communication with the power detector 195 and is configured to control the tuning circuit 155 based on the signal received from the power detector 195. For instance, the controller 200 may receive the signal representing the peak-to-peak power from the power detector 195 and, depending on the value represented by the signal, adjust the variable attenuator 175 and phase shifter 180 accordingly. In one exemplary approach, a high peak-to-peak power indicates that the second cross-polarization component has not been substantially reduced and that further tuning is required. On the other hand, the controller 200 may interpret a DC voltage signal (e.g., a signal representing a peak-to-peak power of zero) as an indication that the second cross-polarization component has been completely or substantially cancelled. Of course, the controller 200 may interpret other signals with non-zero peak-to-peak voltage as an indication that the second cross-polarization component has been substantially cancelled.

The controller 200 may be configured to iteratively adjust the variable attenuator 175, the phase shifter 180, or both using, for instance, digital signal processing. In one exemplary implementation, the controller 200 may hold the settings of the phase shifter 180 constant and change the settings of the variable attenuator 175 until the peak-to-peak voltage signal output by the power detector 195 is minimized. The controller 200 may further hold the settings of the variable attenuator 175 constant and cycle through the various settings of the phase shifter 180 until the minimum peak-to-peak voltage is reached. The controller 200 may repeat this sequence until the second cross-polarization signal is substantially reduced. Of course, the controller 200 may begin by changing the settings of the phase shifter 180 instead of the variable attenuator 175.

The monitoring station 115 may include additional components such as one or more directional couplers 230, a disable switch 235, and one or more spectrum analyzers 240. For instance, a first coupler 230A may be used to sample the co-polarization component from the first portion 165 of the antenna 150. A second coupler 230B may be used to couple the cancelling signal to the second portion 170 of the antenna 150. A third coupler 230C may be used to sample the filtered signal.

The switch 235 may be used to disable the tuning circuit 155, for instance, upon command from the controller 200. For instance, the controller 200 may determine that it is unable to decrease the second cross-polarization component or that its attempts to reduce the second cross-polarization component have actually increased the amount of noise. Therefore, the controller 200 may be configured to disable the tuning circuit 155 by opening the switch 235. Moreover, the switch 235 may further represent a manual switch 235 that may be opened by a technician to disable the tuning circuit 155.

The spectrum analyzers 240A and 240B may include any device configured to measure the frequency, magnitude, or any other characteristic of the repeated signal 125. The spectrum analyzers 240A and 240B may be in communication with the first and second portions 165, 170 of the antenna 150 and receive the co-polarization component of the repeated signal 125 and the filtered signal representing the first cross-polarization component and the substantially reduced second cross-polarization component of the repeated signal 125.

In general, computing system and/or devices, such as the controller 200, the power detector 195, the spectrum analyzers 240A and 240B, etc. may employ any of a number of well known computer operating systems, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Examples of computing devices include, without limitation, a computer workstation, a server, a desktop, notebook, laptop, or handheld computer, or some other known computing system and/or device.

Computing devices generally include computer-executable instructions, where the instructions may be executable by one or more computing devices such as those listed above. Computer-executable instructions may be compiled or interpreted from computer programs created using a variety of well known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

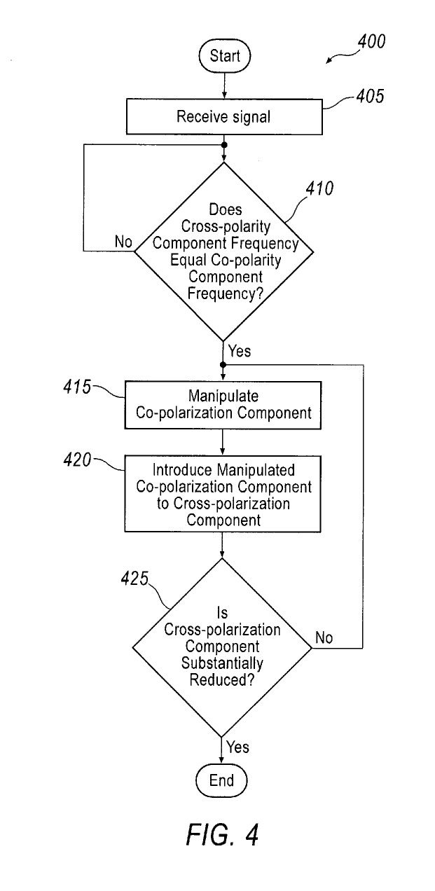

FIG. 4 illustrates an exemplary process 400 that may be implemented by the system 100 illustrated in FIGS. 1-3.

Block 405 includes receiving a signal such as the repeated signal 125 having the co-polarization component and the first cross-polarization components from the satellite 110. The repeated signal 125 may be transmitted by the first and second transponders 140, 145 of the satellite 110 and be received at the antenna 150 of the monitoring station 115. The antenna 150 may isolate the co-polarization component and the first cross-polarization component of the repeated signal 125 using a polarizer. Doing so, however, may generate the second cross-polarization component as noise. The first portion 165 of the antenna 150 may receive the co-polarization component and the second portion 170 of the antenna 150 may receive the first and second cross-polarization components.

Decision block 410 may include determining whether one of the cross-polarity components has the same frequency as the co-polarization component. If not, no noise was generated by the polarizer of the monitoring station 115 and the process 400 repeats block 410 until one of the cross-polarity components has the same frequency as the co-polarization component. If so, the process 400 may continue with block 415.

Block 415 may include manipulating the co-polarization component of the repeated signal 125 with a tuning circuit 155. The tuning circuit 155 may include the phase shifter 180 to shift the phase of the co-polarization component and the variable attenuator 175 to attenuate the co-polarization component. The output of the tuning circuit 155 is the cancelling signal. The cancelling signal is a manipulated version of the co-polarization component. For instance, the cancelling signal has the same frequency, but opposite phase, as the co-polarization component. The cancelling signal also has the same frequency and magnitude as the second cross-polarization component, but opposite phase.

Block 420 includes introducing the manipulated co-polarization component to the plurality of cross-polarization components to substantially reduce at least one of the cross-polarization components. The manipulated co-polarization component is represented as the cancelling signal. Again, the cancelling signal has the same frequency and magnitude, but opposite phase, as the second cross-polarization component. Therefore, when added to the second portion 170 of the antenna 150, the cancelling signal cancels the second cross-polarization component.

Decision block 425 includes determining whether the second cross-polarization component is substantially reduced. For instance, the feedback circuit 160 may determine whether the cancelling circuit has substantially reduced the second cross-polarization component. If not, the process 400 may go to block 415. The controller 200 of the feedback circuit 160 may iteratively adjust the parameters of the phase shifter 180 and variable attenuator 175 until the second cross-polarization signal is substantially reduced. Once substantially reduced, the process 400 may end after block 425.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A system comprising:
a remote station configured to transmit a first signal having a co-polarization component and a first cross-polarization component;
a satellite configured to receive the first signal and transmit a repeated signal that substantially includes the first signal; and
a monitoring station in communication with the satellite and configured to isolate the repeated signal received from the satellite, wherein isolating the repeated signal generates a second signal having the co-polarization component, the first cross-polarization component, and a second cross-polarization component, and wherein the monitoring station is further configured to substantially reduce the second cross-polarization component of the second signal.

2. A system as set forth in claim 1, wherein the co-polarization component and the second cross-polarization component have the same frequency.

3. A system as set forth in claim 2, wherein the monitoring station is configured to identify the second cross-polarization component from the frequency of the co-polarization component.

4. A system as set forth in claim 1, wherein the monitoring station includes at least one spectrum analyzer configured to receive the co-polarization component and the first cross-polarization component.

5. A system as set forth in claim 1, wherein the monitoring station includes an antenna having a first portion configured to receive the co-polarization component and a second portion configured to receive the first cross-polarization component and the second cross-polarization component.

6. A system as set forth in claim 5, wherein the monitoring station includes a tuning circuit in communication with the antenna and configured to reduce the second cross-polarization component from the second signal.

7. A system as set forth in claim 6, wherein the tuning circuit includes a variable attenuator in communication with the first portion of the antenna and configured to attenuate the co-polarization component of the second signal.

8. A system as set forth in claim 7, wherein the tuning circuit includes a phase shifter in communication with the first portion of the antenna and configured to shift a phase of the co-polarization component of the second signal.

9. A system as set forth in claim 7, wherein the monitoring station includes a feedback circuit in communication with the tuning circuit.

10. A system as set forth in claim 9, wherein the feedback circuit includes a controller configured to iteratively adjust the tuning circuit until the second cross-polarization component of the second signal is substantially reduced.

11. An apparatus comprising:
a tuning circuit configured to substantially reduce at least one cross-polarization component of a signal; and
a feedback circuit having a power detector and a controller in communication with the tuning circuit, wherein the controller is configured to iteratively adjust the tuning circuit until the at least one cross-polarization component of the signal is substantially reduced based on a power of the cross-polarization component measured by the power detector.

12. An apparatus as set forth in claim 11, wherein the tuning circuit includes a variable attenuator configured to attenuate a co-polarization component of the signal.

13. An apparatus as set forth in claim 11, wherein the tuning circuit includes a phase shifter configured to shift a phase of the co-polarization component of the signal.

14. An apparatus as set forth in claim 11, wherein the power detector configured to output a power signal having a voltage representative of the peak-to-peak power of the cross-polarization component to the controller, and wherein the controller is configured to iteratively adjust the tuning circuit based on a peak-to-peak voltage of the power signal.

15. An apparatus as set forth in claim 17, wherein the controller is configured to iteratively adjust the tuning circuit based on the power signal by holding settings of a phase shifter constant and adjusting settings of a variable attenuator.

16. An apparatus as set forth in claim 15, wherein the controller is configured to iteratively adjust the tuning circuit based on the power signal by holding the settings of the variable attenuator constant and adjusting the settings of the phase shifter.

17. An apparatus as set forth in claim 11, wherein at least one of the cross-polarization components of the signal has the same frequency as the co-polarization component of the signal.

18. A method comprising:
receiving a signal having a co-polarization component and a plurality of cross-polarization components, at least a sub-set of the cross-polarization components representing different signal sources;
manipulating the co-polarization component; and
introducing the manipulated co-polarization component to the plurality of cross-polarization components to substantially reduce at least one of the cross-polarization components.

19. A method as set forth in claim 18, wherein manipulating the co-polarization component includes attenuating the co-polarization component.

20. A method as set forth in claim 18, wherein manipulating the co-polarization component includes shifting a phase of the co-polarization component.

21. A method as set forth in claim 18, wherein receiving the signal includes receiving the signal at an antenna having a first portion configured to receive the co-polarization component and a second portion configured to receive the plurality of cross-polarization components.

22. A method as set forth in claim 21, wherein introducing the manipulated co-polarization component to the plurality of cross-polarization components includes introducing the manipulated co-polarization component to the second portion of the antenna.
